(19) United States
(12) Patent Application Publication
(10) Pub. No.: US 2019/0301502 A1
(43) Pub. Date: Oct. 3, 2019

(54) COMBINATION STRUCTURE OF BASE MEMBER AND ERECT MEMBER AND MANUFACTURING METHOD THEREOF

(71) Applicant: G. E. PRODUCTS CO., LTD., New Taipei City (TW)

(72) Inventor: FANG-CHOU CHO, New Taipei City (TW)

(21) Appl. No.: 16/058,633

(22) Filed: Aug. 8, 2018

(30) Foreign Application Priority Data
Apr. 3, 2018 (TW) 107111982
Jun. 19, 2018 (TW) 107121021

(51) Int. Cl. F16B 9/00; B43K 25/02; A44B 6/00

(52) U.S. Cl. CPC F16B 9/054; E04G 21/16; A44B 6/00; B43K 25/026

(57) ABSTRACT

A combination structure for a base member and an erect member, and a manufacturing method thereof, are disclosed. The combination structure includes a base member comprising a slot and a through hole in communications with the slot. An erect member is inserted into the slot, and a combining member detachably engages with the through hole. The combining member thereby fixedly positions the erect member in the slot when the combining member is joined to the through hole.

### BACKGROUND OF THE INVENTION

### Field of the Invention

The invention relates to a combination structure of a base member and an erect member and a manufacturing method thereof, and more particularly to a combination structure utilizing a combining member engaging the base member and the erect member simultaneously so as to join the base member and the erect member together and a manufacturing method for the combination structure.

### Description of the Related Art

In technical the fields of mechanical engineering and civil engineering, a combination structure of a base member and an erect member is often used. A conventional combination structure for the base member and the erect member is formed by welding. However, the welding process takes much more labor and time, and the costs and the overall construction times are thus increased.

### BRIEF SUMMARY OF THE INVENTION

The invention provides a combination structure of a base member and an erect member and a manufacturing method thereof. The combination structure utilizes a combining member engaging the base member and the erect member simultaneously so as to join together the base member and the erect member.

The combination structure in accordance with an exemplary embodiment of the invention includes a base member comprising a slot and a through hole communicated with the slot. An erect member is inserted into the slot, and a combining member is detachably joined to the through hole, wherein the combining member positions the erect member in the slot when the combining member is joined to the through hole.

The manufacturing method for the combination structure in accordance with an exemplary embodiment of the invention includes the following steps: providing a base member; forming a slot and a through hole on the base member, wherein the through hole communicates with the slot; providing an erect member; providing a combining member; and inserting the erect member into the slot and joining the combing member with the through hole so as to position the erect member in the slot.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a perspective exploded view of an embodiment of a combination structure of a base member and an erect member;

FIG. 2 is a perspective assembly view of the combination structure of FIG. 1;

FIG. 3 is a partial cross-sectional view of the combination structure of FIG. 2;

FIG. 4 a perspective exploded view of another embodiment of a combination structure of a base member and an erect member;

FIG. 5 is a perspective assembly view of the combination structure of FIG. 4;

FIG. 6 is a perspective exploded view of the combination structure of an embodiment of the invention applied to a steel beam;

FIG. 7 is a perspective assembly view of the combination structure of an embodiment of the invention applied to a steel beam;

FIGS. 8 and 9 are perspective assembly views of the combination structure of an embodiment of the invention applied to a pen clip;

FIG. 10 is a perspective assembly view of the combination structure of an embodiment of the invention applied to a necktie clip; and

FIG. 11 is a flow chart of a manufacturing method of a combination structure of a base member and an erect member.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

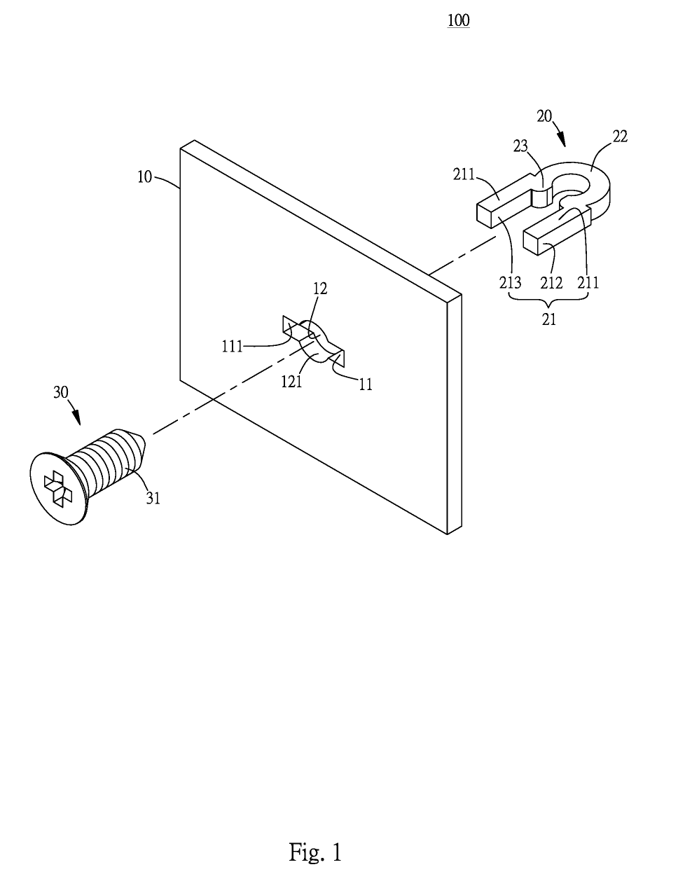

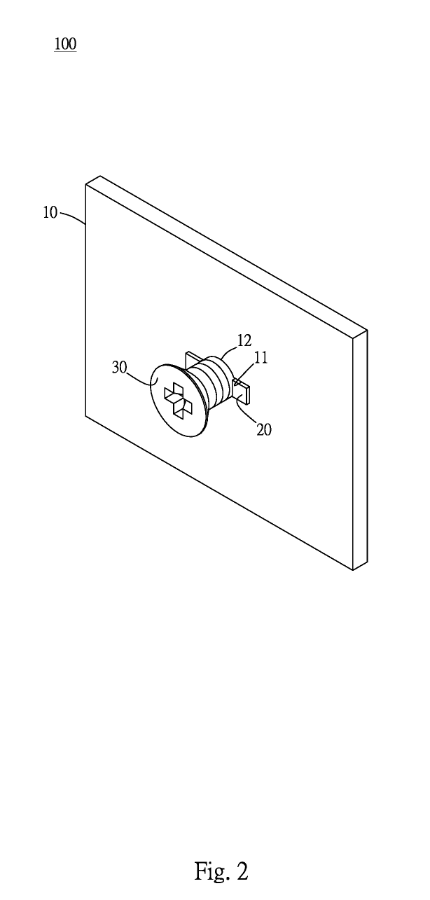

Referring to FIGS. 1, 2 and 3, an embodiment combination structure 100 of a base member and an erect member of the invention includes a base member 10, an erect member 20 and a combining member 30. The base member 10 includes a slot 11 and a through hole 12. The slot communicates with the through hole 12. The erect member 20 is configured to be inserted into the slot 11. The combining member 30 is configured to be detachably joined to the through hole 12. When the combining member 30 is joined to the through hole 12, the combining member 30 positions the erect member 20 in the slot 11. In this embodiment, the base member 10 is a base plate, and the slot 11 and the through hole 12 are formed in the base plate 10. The center of the through hole 12 coincides with the center of the slot 11. The erect member 20 is perpendicularly inserted into the slot 11 with respect to the base member 10. After the erect member 20 is inserted into the slot 11, the combining member 30 is inserted into the through hole 12. Since the slot 11 communicates with the through hole 12, the combining member 30 engages an inner wall of the through hole 12 and a portion of the erect member 20 simultaneously, whereby the base member 10 is joined to the erect member 20 by way of the combining member 30. Although the through hole 12 is located at the center of the slot 11, the invention is not limited thereto. In other embodiments, the through hole communicates with the slot at one end of the slot or on one lateral side of the slot. In addition, the slot 11 can be a through slot which allows the erect member 20 to extend through the base member 10 or a blind slot which does not allow the erect member 20 to extend through the base member 10.

In this embodiment, the erect member 20 includes a positioning portion 21 and a latch portion 22. The positioning portion 21 is configured to be inserted into the slot 11, and the latch portion 22 is connected to the positioning portion 21. In this embodiment, the positioning portion 21 includes two extended arms 211, and the latch portion 22 is curved. The extended arms 211 extend in parallel from two respective ends of the latch portion 22. As described, since the through hole 12 is located at the the center of the slot 11, two ends of the slot 11 are located on two opposite sides of the through hole 12. When the positioning portion 21 is inserted perpendicularly into the slot 11, the extending arms 211 are perpendicularly inserted into the slot 11 and each is located between the through hole 12 and the respective end 111 of the slot 11. A surface 212 of each extending arm 211 abuts against the respective end 111 of the slot 11, and another surface 213 of the extending arm 211 is positioned slightly into the through hole 12. In this embodiment, the combining member 30 includes a screw with a thread portion 31. When the combining member 30 is screwed into the through hole 12, the screw thread portion 31 forms screw threads on an inner wall 121 of the through hole 12. Since the extending arms 211 extend slightly into the through hole 12, the screw thread portion 31 also forms screw threads on the surfaces 213 of the extending arms 211, whereby the combining member 30 thus engages the base member 10 and the erect member 20 so that the erect member 20 is joined to the base member 10. In some embodiments, the combining member 30 is a bolt.

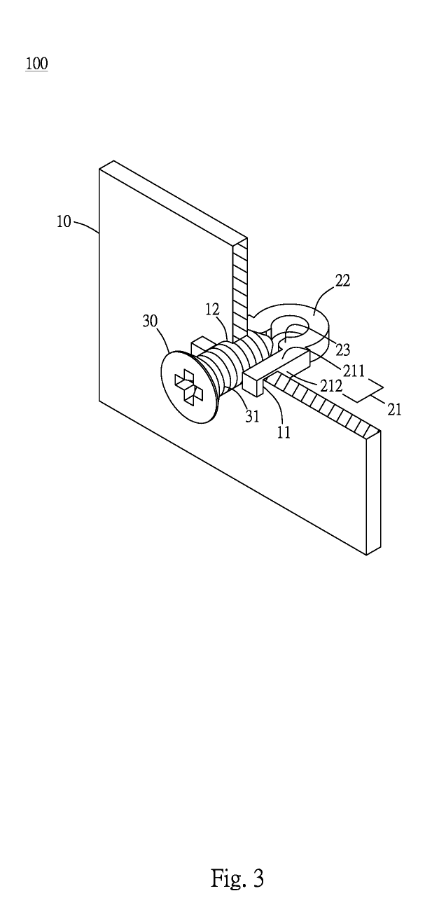

As illustrated in FIG. 3, the erect member 20 further includes a stop portion 23. The stop portion 23 is connected to the positioning portion 21 and protrudes from the surfaces 213 of the positioning portions 21. The latch portion 22 is connected to the stop portion 23. When the combining member 30 is inserted into a predetermined position in the through hole 12 and a tip of the combining member 30 contacts the stop portion 23, any further insertion of the combining member 30 is stopped by the stop portion 23. When the combining member 30 is a bolt, the bolt is screwed into the through hole 12 until a head of the bolt contacts a surface of the base member 10 and the bolt is thus stopped by the base member 10 even though the tip of the combining member 30 has not yet contacted the stop portion 23.

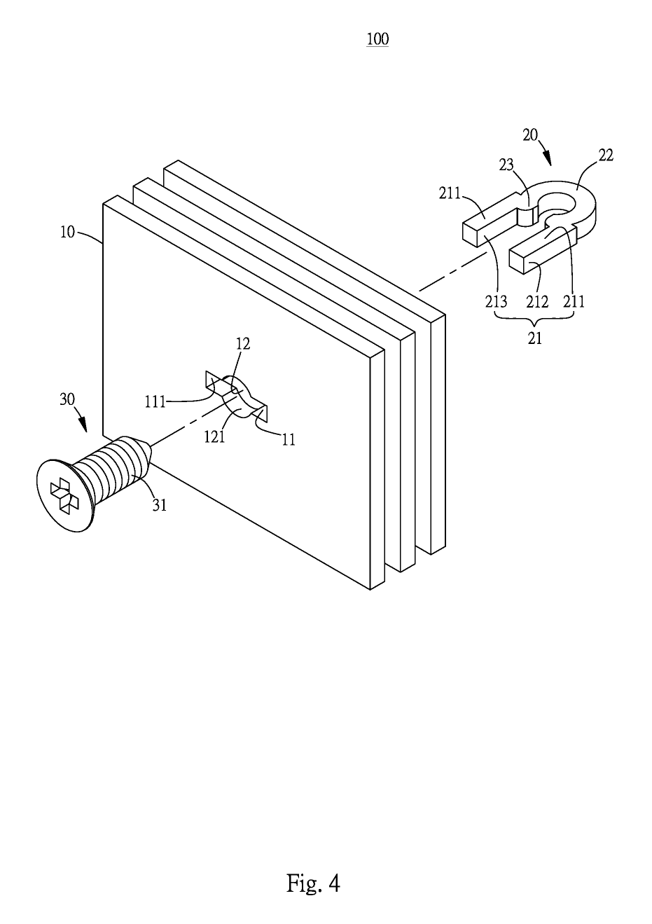

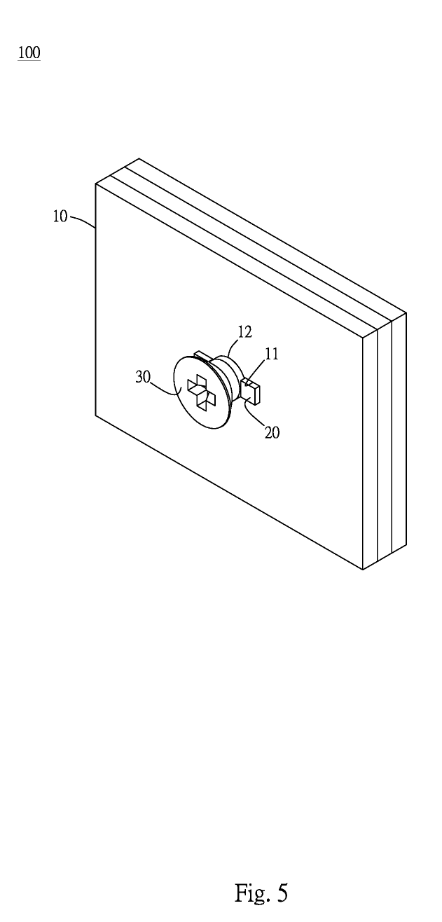

Referring to FIGS. 4 and 5, another embodiment of the combination structure of a base member and an erect member of the invention is disclosed. This embodiment has a structure similar to the embodiment of FIGS. 1 to 3, and the same elements of these two embodiments are given the same reference numbers and the descriptions of them are thus omitted. The difference between this embodiment and the embodiment of FIGS. 1 to 3 is that this embodiment has three overlapping base plates as the base member 10, whereas the embodiment of FIGS. 1 to 3 has one base plate as the base member 10. The base member 10 of this embodiment includes a plurality of base plates, and each bae plate has a slot 11 and a through hole 12 communicating with the slot 11. The slots 11 of the base plates are aligned, and the through holes 12 of the base plate are also aligned. The erect member 20 is inserted into the aligned slots 11, and the combining member 30 is inserted into the aligned through holes 12, whereby the erect member 20 is joined to the base member 10 and the three base plates of the base member 10 are also joined together.

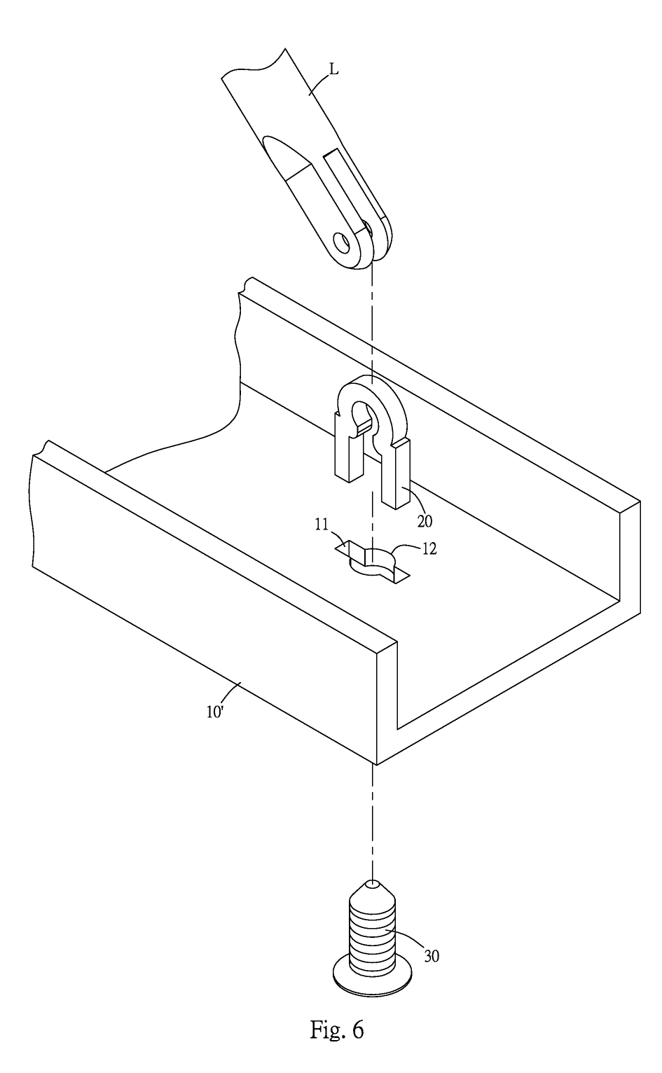

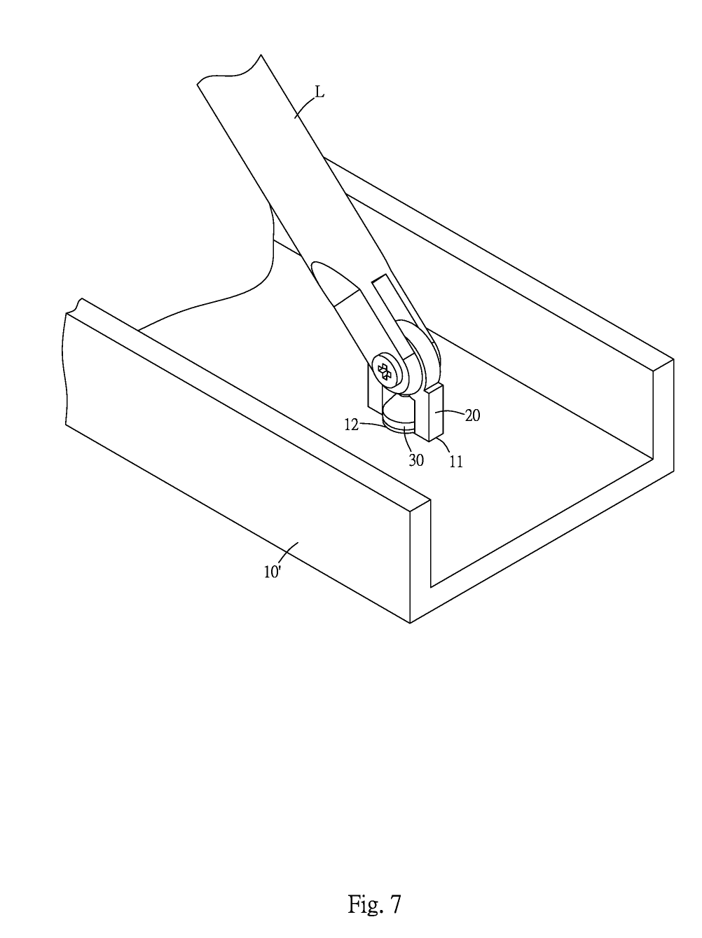

Referring to FIGS. 6 and 7, an embodiment of the combination structure of the base member and the erect member is applied to a steel beam. In this embodiment, the base member is a steel beam 10′, and the slot 11 and the through hole 12 are formed on the steel beam 10′. The erect member 20 is inserted into the slot 11 as described above, and the combining member 30 is inserted into the through hole 12 so as to position the erect member 20 in the slot 11. A pull bar L is joined to the latch portion 22 of the erect member 20 by way of a bolt or pin through eyelet of portion 22. Therefore, the pull bar L is easily joined to the steel beam 10′ through the combined structure of the base member and the erect member. When the pull bar L is to be detached, only the combining member 30 is detached from the base member 10′ and the erect member 20, and the pull bar L is then detached from the steel beam 10′.

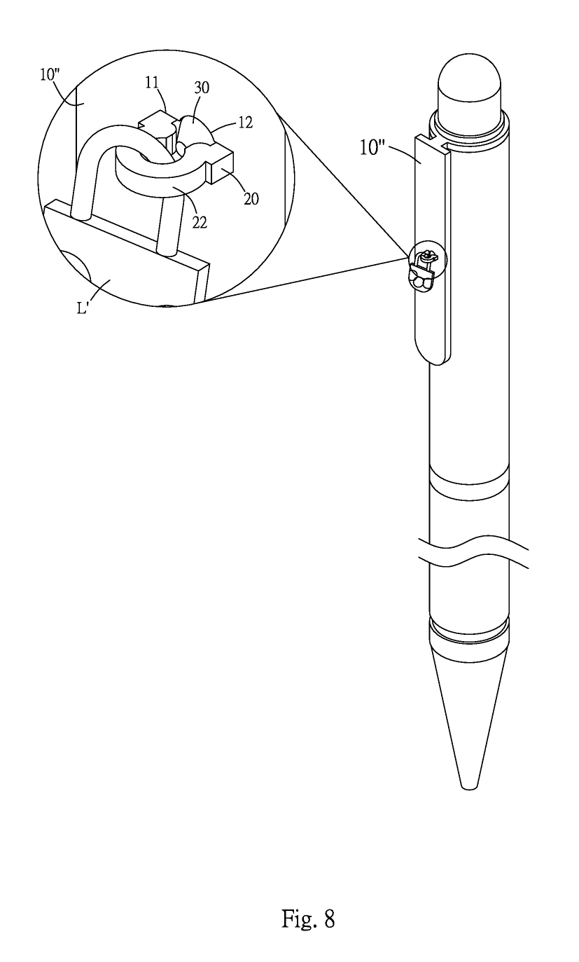

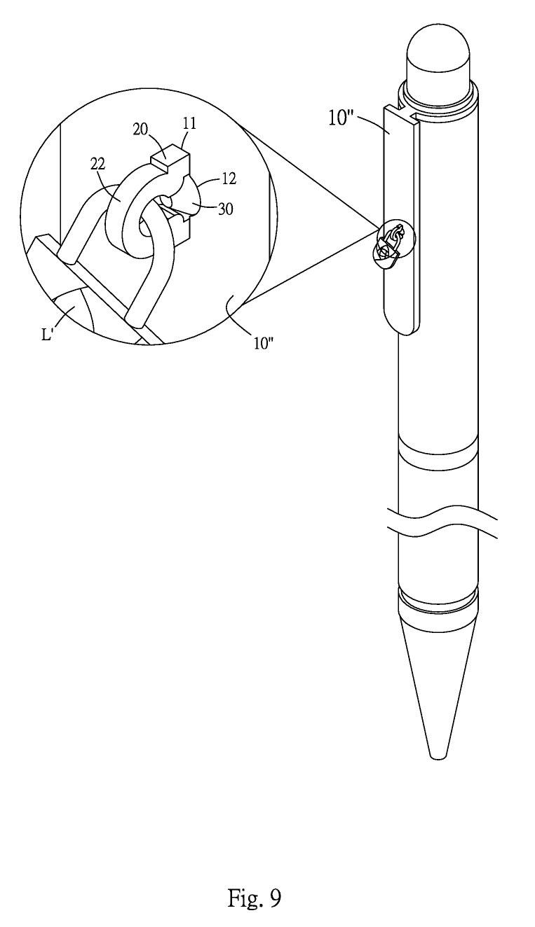

Referring to FIGS. 8 and 9, the combination structure of an embodiment of the invention is applied to a pen clip. In this embodiment, the base member 10″ is a pen clip. The slot 11 and the through hole 12 are formed on the base member 10″. The erect member 20 is inserted into the slot 11 as described. The combining member 30 is inserted into the through hole 12 so as to position the erect member 20 in the base member 10″. The slot 11 extends in a direction perpendicular to the longitudinal direction of the pen clip (as shown in FIG. 8) or parallel to the longitudinal direction of the pen clip (as shown in FIG. 9) so that the erect member 20 is positioned perpendicular to the longitudinal direction of the pen clip (as shown in FIG. 8) or parallel to the longitudinal direction of the pen clip (as shown in FIG. 9). A decoration L′ is connected to the eyelet of latch portion 22 of the erect member 20. The decoration L′ is easily assembled to the main body through the combined structure of the invention.

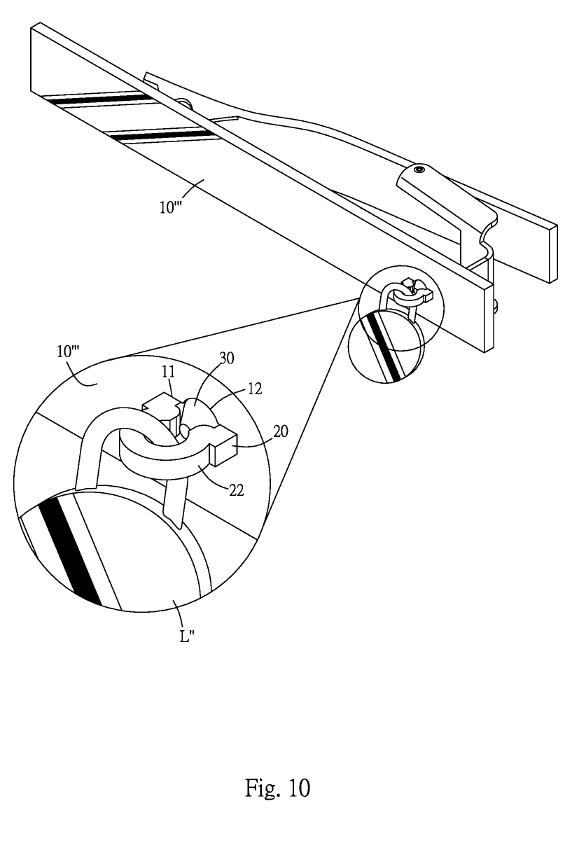

Referring to FIG. 10, the combination structure of an embodiment of the invention is applied to a necktie clip. The base member 10′″ is the necktie clip. The slot 11 and the through hole 12 are formed on the base member 10′″. The erect member 20 is inserted into the slot 11 as described. The combining member 30 is inserted into the through hole 12 so as to position the erect member 20 in the base member 10′″, and a decoration L″ is connected to the latch portion 22 of the erect member 20. The decoration L″ is easily assembled to the necktie clip through the combination structure of the invention.

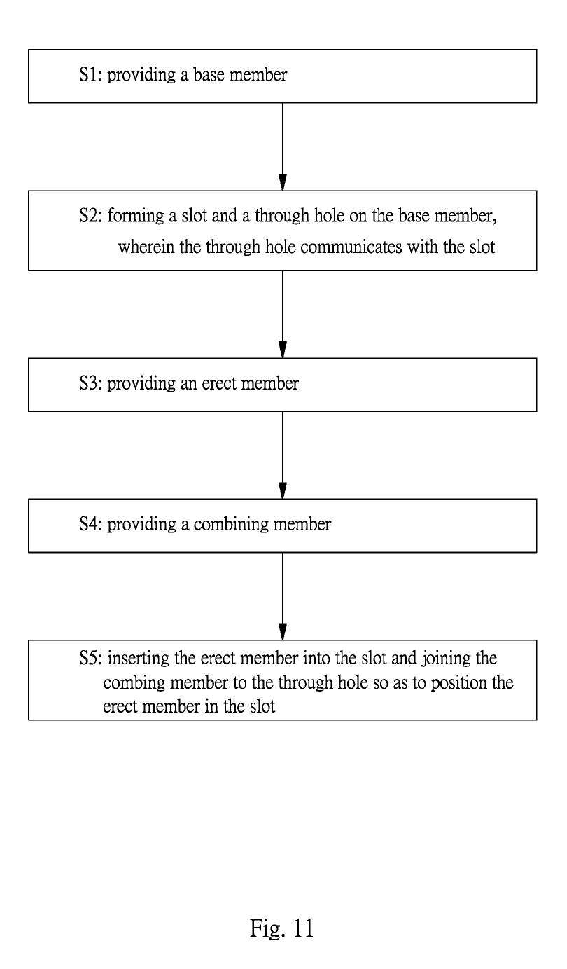

Referring to FIG. 11, an embodiment of a manufacturing method for the combination structure of the base member and the erect member is disclosed.

In a step S1, a base member is provided. In this embodiment, the base member includes one or more base plates. Afterwards, the procedure enters a step S2.

In step S2, a slot and a through hole are formed in the base member, and the slot communicates with the through hole. Afterwards, the procedure enters a step S3. In this embodiment, the slot and the through hole are formed by punching. In addition, as shown in FIG. 1 or FIG. 4, the center of the slot coincides with the center of the through hole so that the through hole is located at the center of the slot. The invention is not limited thereto. In other embodiments, the through hole communicates with the slot at one end of the slot or on one lateral side of the slot.

In step S3, an erect member is provided. In this embodiment, as shown in FIG. 1 or 4, the erect member 20 includes a positioning portion 21 and a latch portion 22. The positioning portion 21 includes two extending arms 211, and the latch portion 22 is curved. The extending arms 211 extend in parallel from two ends of the latch portion 22 respectively. Afterwards, the procedure enters a step S4.

In step S4, a combining member is provided. In this embodiment, the combining member includes a screw thread portion. Preferably, the combining member is a bolt or screw. Afterwards, the procedure enters a step S5.

In step S5, the erect member is inserted into the slot of the base member, and the combining member is inserted into the through hole of the base member. In this embodiment, the screw thread portion of the combining member engages the through hole and the positioning portion of the erect member and thus forms screw threads on an inner wall of the through hole and a surface of the positioning portion of the erect member. The insertion of the combining member also pushes the positioning portion to prop against an inner wall of the slot. The combination structure of the base member and the erect member refers, for example, to the combination structures illustrated by FIGS. 1 to 7.

The combination structure of the invention utilizes the combining member to engage the base member and the erect member simultaneously, whereby the erect member is joined to the base member through the combining member. This combination structure is easily detached. Compared with the conventional combination structure formed by welding, it is easier to form the combination structure of the invention, which reduces the construction time and labor, and thus reduces costs.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A combination structure of a base member and an erect member, comprising:
a base member comprising a slot and a through hole in communication with the slot;
an erect member inserted into the slot; and
a combining member detachably joined to the through hole, wherein the combining member positions the erect member in the slot when the combining member is joined to the through hole.

2. The combination structure as claimed in claim 1, wherein the base member comprises at least one base plate, and the slot and the through hole are formed in the base plate.

3. The combination structure as claimed in claim 2, wherein the erect member comprises a positioning portion configured to be inserted into the slot and a latch portion connected to the positioning portion.

4. The combination structure as claimed in claim 3, wherein the positioning portion is perpendicularly inserted into the slot.

5. The combination structure as claimed in claim 3, wherein the combining member comprises a screw thread portion configured to engage the through hole and the positioning portion inserted into the slot, and the screw thread portion forms screw threads on an inner wall of the through hole and a surface of the positioning portion.

6. The combination structure as claimed in claim 5, wherein the erect member further comprises a stop portion connected to the positioning portion and protrudes from the surface of the positioning portion, and the latch portion is connected to the stop portion.

7. The combination structure as claimed in claim 5, wherein the positioning portion abuts against an inner wall of the slot.

8. The combination structure as claimed in claim 1, wherein the erect member comprises a positioning portion configured to be inserted into the slot and a latch portion connected to the positioning portion.

9. The combination structure as claimed in claim 8, wherein the positioning portion is perpendicularly inserted into the slot.

10. The combination structure as claimed in claim 8, wherein the combining member comprises a screw thread portion configured to join the through hole and the positioning portion inserted into the slot, and the screw thread portion forms screw threads on an inner wall of the through hole and a surface of the positioning portion.

11. The combination structure as claimed in claim 10, wherein the erect member further comprises a stop portion connected to the positioning portion and protrudes from the surface of the positioning portion, and the latch portion is connected to the stop portion.

12. The combination structure as claimed in claim 10, wherein the positioning portion abuts against an inner wall of the slot.

13. The combination structure as claimed in claim 1, wherein the base member is a steel beam, and the erect member is a pull bar.

14. The combination structure as claimed in claim 1, wherein the base member is a pen clip, and the erect member is a decoration.

15. The combination structure as claimed in claim 1, wherein the base member is a necktie clip, and the erect member is a decoration.

16. A manufacturing method of a combination structure, comprising:
providing a base member;
forming a slot and a through hole in the base member, wherein the through hole communicates with the slot;
providing an erect member;
providing a combining member; and
inserting the erect member into the slot and joining the combing member to the through hole so as to position the erect member in the slot.

17. The manufacturing method as claimed in claim 16, wherein the erect member comprises a positioning portion which is straight and a latch portion which is curved, and the positioning portion is inserted into the slot.

18. The manufacturing method as claimed in claim 17, wherein the combining member comprises a screw thread portion configured to join the through hole and the positioning portion inserted into the slot, the screw thread portion forms screw threads on an inner wall of the through hole and a surface of the positioning portion, and the positioning portion abuts against an inner wall of the slot.

19. The manufacturing method as claimed in claim 16, wherein the combining member comprises a screw thread portion configured to join the through hole and the positioning portion inserted into the slot, the screw thread portion forms screw threads on an inner wall of the through hole and a surface of the positioning portion, and the erect member abuts against an inner wall of the slot.
